(19) United States
(12) Patent Application Publication
(10) Pub. No.: US 2025/0119233 A1
(43) Pub. Date: Apr. 10, 2025

(54) MULTI-USER EDMG AGGREGATE PPDU STRUCTURE

(71) Applicant: HUAWEI TECHNOLOGIES CO., LTD., SHENZHEN (CN)

(72) Inventors: Yan XIN, Kanata (CA); Rui DU, Kanata (CA); Jung Hoon SUH, Kanata (CA); Osama ABOUL-MAGD, Kanata (CA); Kwok Shum AU, Kanata (CA)

(73) Assignee: HUAWEI TECHNOLOGIES CO., LTD., SHENZHEN (CN)

(21) Appl. No.: 18/988,023

(22) Filed: Dec. 19, 2024

Related U.S. Application Data
(63) Continuation of application No. PCT/CN2022/109275, filed on Jul. 30, 2022.

(51) Int. Cl. H04L 1/00; H04W 28/06; H04W 84/12

(52) U.S. Cl. CPC H04L 1/0007; H04W 28/065; H04W 84/12

(57) ABSTRACT

There is provided a PPDU structure along with associated methods and apparatus. In various embodiments, the PPDU structure can be characterized as a Multi-User EDMG Aggregate PPDU Structure. That is, the PPDU can be transmitted to multiple users or destinations (e.g. STAs), compliant with EDMG requirements, and exhibit characteristics of an A-PPDU. The PPDU structure can be used for multi-static sensing or potentially for other applications.

### CROSS-REFERENCE TO RELATED APPLICATION

This application is a continuation of International Patent Application No. PCT/CN2022/109275, filed on Jul. 30, 2022, the disclosure of which is hereby incorporated by reference in its entirety.

### TECHNICAL FIELD

The present invention pertains in general to the field of radio communications, and in particular to an IEEE 802.11 physical layer protocol data unit (PPDU) structure to be used for example as a multi-user PPDU in data communications and/or a sounding PPDU in multi-static sensing.

### BACKGROUND

The IEEE 802.11ay (Enhanced Directional Multi-Gigabit (EDMG)) standard specifies an efficient physical layer protocol data unit (PPDU) transmission feature, called aggregate PPDU (A-PPDU), in which multiple PPDUs are aggregated sequentially by sharing legacy short training field (L-STF), legacy CEF (L-CEF), legacy Header field (L-Header), EDMG-STF, EDMG-channel estimation field (CEF) and training (TRN) fields. A-PPDU in EDMG is a single-user (SU) PPDU that is transmitted from one station (STA) to another STA.

The IEEE 802.11bf standard is intended to amend the existing wireless local area network (WLAN) standards to enhance sensing capabilities through IEEE 802.11-compliant waveforms. Using IEEE 802.11bf, a station (STA) can detect features (e.g., range, velocity, angular, motion, presence or proximity, gesture, etc.) of intended targets (e.g., objects, humans, animals, etc.) in an environment (e.g., house, office, room, vehicle, enterprise, etc.) using received Wi-Fi signals.

The IEEE 802.11bf standard includes modifications to the medium access control (MAC) and physical layer (PHY) of the existing IEEE 802.11 standard to enhance the WLAN sensing capabilities in the unlicensed bands between 1 GHz and 7.125 GHz (sub-7 GHz) and in the 60 GHz band. WLAN sensing may include multi-static sensing, in which a sounding PPDU is transmitted from an initiator device to a plurality of responder devices. This sounding PPDU can be transmitted with directional beams and can be received by the responder devices.

However, existing proposals for the format of MU-PPDU have potential issues relating to backward compatibility and coexistence. Therefore, there is a need for a MU-PPDU structure that obviates or mitigates one or more deficiencies of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a PPDU structure, for example as that terminology pertains to an IEEE 802.11 PPDU, along with associated methods and apparatus. In various embodiments, the PPDU structure can be characterized as a multi-User EDMG Aggregate PPDU Structure. That is, the PPDU can be transmitted to multiple users or destinations (e.g. STAs), compliant with EDMG requirements, and exhibit characteristics of an A-PPDU. The PPDU structure can be used for multi-static sensing or potentially for other applications.

In accordance with an embodiment of the present disclosure, there is provided a method which includes generating, by a device, a physical layer (PHY) protocol data unit (PPDU). The PPDU includes a first contiguous portion and a second contiguous portion. The first contiguous portion includes a first contiguous sub-portion including a first legacy short training field (L-STF), a first legacy channel estimation field (L-CEF), a first legacy header (L-Header), and a first enhanced directional multi-gigabit (EDMG) header-A (EDMG-Header-A). The first contiguous portion further includes a second contiguous sub-portion including a first EDMG short training field (EDMG-STF), a first EDMG channel estimation field (EDMG-CEF), and optionally a first data portion. The first contiguous portion further includes a first synchronization field specific to a first station (STA). The second contiguous portion includes a third contiguous sub-portion including a second L-STF, a second L-CEF, a second L-Header, and a second EDMG-Header-A. The second contiguous portion further includes a fourth contiguous sub-portion including a second EDMG-STF, a second EDMG-CEF, and optionally a second data portion. The second contiguous portion further includes a second synchronization field specific to a second station (STA).

It is to be understood that a contiguous portion or sub-portion may denote that the multiple fields of the portion or sub-portion are adjacent to one another. Additionally or alternatively, a portion or sub-portion may be continuous, for example in that the portion or sub-portion is uninterrupted.

The method further includes transmitting, by the device, the PPDU, with the first contiguous portion directionally transmitted toward the first STA and the second contiguous portion directionally transmitted toward the second STA. The first contiguous sub-portion and the third contiguous sub-portion are modulated using a legacy, pre-EDMG modulation format. The second contiguous sub-portion and the fourth contiguous sub-portion are modulated using an EDMG modulation format. In addition, either the first synchronization field is included in the first contiguous sub-portion and the second synchronization field is included in the third contiguous sub-portion or the first synchronization field is included in the second contiguous sub-portion and the second synchronization field is included in the fourth contiguous sub-portion.

In some embodiments, the PPDU further includes a padding field 542 modulated using the EDMG format and located after the second contiguous portion, the padding field directionally transmitted toward the first STA. In some embodiments the PPDU further comprises a first one or more training subfields 546 directionally transmitted toward the first STA and a second one or more training subfields 548 directionally transmitted toward the second STA.

In some embodiments, the first synchronization subfield includes a first sequence selected from a set of orthogonal sequences, the first sequence assigned to the first STA, or the second synchronization subfield includes a second sequence selected from the set of orthogonal sequences, the second sequence assigned to the second STA, or both. In some embodiments, the first synchronization subfield further includes another first sequence allocated prior to the first orthogonal sequence in time to facilitate implementation of a delay of decoding of the first EDMG-Header-A, or the second synchronization subfield further includes another second sequence allocated prior to the second orthogonal sequence in time to facilitate implementation of a delay of decoding of the second EDMG-Header-A.

In accordance with an embodiment of the present disclosure, there is provided a method which includes generating, by a device, a physical layer (PHY) protocol data unit (PPDU). The PPDU includes a first contiguous portion and a second contiguous portion. The first contiguous portion includes a first contiguous sub-portion including a first legacy short training field (L-STF), a first legacy channel estimation field (L-CEF), a first legacy header (L-Header), and a first enhanced directional multi-gigabit (EDMG) header-A (EDMG-Header-A). The first contiguous portion further includes a second contiguous sub-portion including a first EDMG short training field (EDMG-STF) and a first synchronization field specific to a first station (STA). The second contiguous portion includes a third contiguous sub-portion including a second L-STF, a second L-CEF, a second L-Header, and a second EDMG-Header-A. The second contiguous portion further includes a fourth contiguous sub-portion including a second EDMG-STF and a second synchronization field specific to a second station (STA). The method further includes transmitting, by the device, the PPDU, with the first contiguous portion directionally transmitted toward the first STA and the second contiguous portion directionally transmitted toward the second STA. The first contiguous sub-portion and the third contiguous sub-portion are modulated using a legacy, pre-EDMG modulation format. The second contiguous sub-portion and the fourth contiguous sub-portion are modulated using an EDMG modulation format. In addition, either the first synchronization field is included in the first contiguous sub-portion and the second synchronization field is included in the third contiguous sub-portion or the first synchronization field is included in the second contiguous sub-portion and the second synchronization field is included in the fourth contiguous sub-portion.

According to embodiments, the second contiguous sub-portion includes a first padding field, or the fourth contiguous sub-portion includes a second padding field, or both. According to embodiments, the PPDU further comprises a first one or more training subfields directionally transmitted toward the first STA and a second one or more training subfields directionally transmitted toward the second STA.

According to embodiments, the first synchronization subfield includes a first sequence selected from a set of orthogonal sequences, the first sequence assigned to the first STA, or the second synchronization subfield includes a second sequence selected from the set of orthogonal sequences, the second sequence assigned to the second STA, or both. According to embodiments, the first synchronization subfield further includes another first sequence allocated prior to the first orthogonal sequence in time to facilitate implementation of a delay of decoding of the first EDMG-Header-A, or the second synchronization subfield further includes another second sequence allocated prior to the second orthogonal sequence in time to facilitate implementation of a delay of decoding of the second EDMG-Header-A, or both.

In accordance with an embodiment of the present disclosure, there is provided a method which includes generating, by a device, a physical layer (PHY) protocol data unit (PPDU). The PPDU includes a first contiguous portion and a second contiguous portion. The first contiguous portion includes a first contiguous sub-portion including a first legacy short training field (L-STF), a first legacy channel estimation field (L-CEF), a first legacy header (L-Header), and a first enhanced directional multi-gigabit (EDMG) header-A (EDMG-Header-A). The first contiguous portion further includes a second contiguous sub-portion including a first EDMG short training field (EDMG-STF), and a first EDMG channel estimation field (EDMG-CEF), wherein the first EDMG-CEF is specific to a first station (STA). The second contiguous portion includes a third contiguous sub-portion including a second L-STF, a second L-CEF, a second L-Header, and a second EDMG-Header-A. The second contiguous portion further includes a fourth contiguous sub-portion including a second EDMG-STF, and a second EDMG-CEF different from the first EDMG-CEF, wherein the second EDMG-CEF is specific to a second station (STA). The method further includes transmitting, by the device, the PPDU, with the first contiguous portion directionally transmitted toward the first STA and the second contiguous portion directionally transmitted toward the second STA. The first contiguous sub-portion and the third contiguous sub-portion are modulated using a legacy, pre-EDMG modulation format. The second contiguous sub-portion and the fourth contiguous sub-portion are modulated using an EDMG modulation format.

According to some embodiments, the PPDU further includes a padding field modulated using the EDMG format and located after the second contiguous portion, the padding field directionally transmitted toward the first STA. According to embodiments, the second contiguous sub-portion includes a first data portion, or the fourth contiguous sub-portion includes a second data portion, or both. In some embodiments, the second contiguous sub-portion includes a first padding field, or the fourth contiguous sub-portion includes a second padding field, or both.

In some embodiments, the first EDMG-CEF includes a first orthogonal sequence selected from a set of EDMG-CEFs assigned to the first STA, or the second EDMG-CEF includes a second orthogonal sequence selected from the same set of EDMG-CEFs assigned to the second STA, or both. In some embodiments, the first EDMG-CEF, the second EDMG-CEF, or both, are also used to facilitate channel estimation.

In accordance with an embodiment of the present disclosure, there is provided a method which includes generating, by a device, a physical layer (PHY) protocol data unit (PPDU), the PPDU comprising a plurality of legacy short training fields (L-STFs). The method further includes transmitting, by the device, the PPDU, with each one of the plurality of L-STFs directionally transmitted toward a different respective station (STA). Each one of the plurality of L-STFs is modulated using a legacy, pre-enhanced directional multi-gigabit (EDMG) modulation format.

In some embodiments, the PPDU further comprises at least one portion modulated using an EDMG modulation format.

In accordance with an embodiment of the present disclosure, there is provided a method which includes communicating between two or more devices to determine multi-user (MU), enhanced directional multi-gigabit (EDMG), aggregated physical layer (PHY) protocol data unit (A-PPDU) capabilities. The method further includes generating a PPDU according to any one of the above described methods, in accordance with said determined MU A-PPDU capabilities.

In some embodiments, the two or more devices include one or more IEEE 802.11 access points (APs), two or more IEEE 802.11 stations (STAs), or a combination thereof. In some embodiments, communicating includes exchanging one or more EDMG capability elements carried in one or more frames. In some embodiments, the one or more frames include one or more of: a beacon frame, a probe request frame, and a probe response frame. In some embodiments, the generated PPDU is used for multi-static sensing.

In some embodiments, the generated PPDU includes at least one synchronization field, at least one EDMG channel estimation field (EDMG-CEF), or both, which is specific to a STA to which said at least one synchronization field, at least one EDMG channel estimation field (EDMG-CEF), or both is directionally transmitted.

In some embodiments, the method further includes, during said communicating between the two or more devices or at a subsequent time prior to said generating the PPDU, determining values for each of the at least one synchronization field, the at least one EDMG channel estimation field (EDMG-CEF), or both, which cause said at least one synchronization field, at least one EDMG channel estimation field (EDMG-CEF), or both, to be specific to said STA.

In some embodiments, the one or more of the EDMG-CEFs are also used to facilitate channel estimation. In some embodiments, determining values for each of the at least one synchronization field is performed during an association or sensing measurement setup phase prior to generating the PPDU for use in multi-static sensing.

In accordance with an embodiment of the present disclosure, there is provided a method which includes generating, by a device, a physical layer (PHY) protocol data unit (PPDU), the PPDU being formatted for use in multi-static sensing. The PPDU includes one or more synchronization (SYNC) fields and a synchronization pad (SYNC Pad) field. If the PPDU includes a data field: in an enhanced directional multi-gigabit (EDMG)-Header-A, a PHY layer service data unit (PSDU) Length field set to specify a total length of: the data field, plus each one of the one or more SYNC fields, plus the SYNC Pad field. If the PPDU excludes the data field: in the enhanced directional multi-gigabit (EDMG)-Header-A, the PHY layer service data unit (PSDU) Length field is set to specify a total length of: each one of the one or more SYNC fields, plus the SYNC Pad field. The method further includes transmitting, by the device, the PPDU, such that at least two different portions of the PPDU are directionally transmitted toward different respective stations (STAs).

In some embodiments, the method further includes calculating, by a recipient of the PPDU, a length of PSDU data based on contents of the PSDU Length field in EDMG-Header-A.

In some embodiments, the PPDU further includes a Length field and a Training Length field within a legacy header (L-Header) of the PPDU, the Length field set to specify a total length of all fields of the PPDU from the EDMG-Header-A to the SYNC Pad field, and inclusive of the EDMG-Header-A and the SYNC Pad field, the Length field together with Training Length field set to estimate the whole PPDU duration.

In some embodiments, the method further includes calculating, by a recipient of the PPDU, a length of PSDU data based on contents of the PSDU Length field in EDMG-Header-A.

According to embodiments of the above described methods, the PPDU is an aggregated PPDU (A-PPDU). According to embodiments of the above described methods, the PPDU is used for multi-static sensing.

According to another aspect, a computer readable medium is provided, where the computer readable medium includes instructions, which when executed by a processor of a device, cause the device to carry out one or more of the methods described herein.

In another aspect, a computer program is provided which includes instructions which, when the program is executed by a processor of a computer, cause the computer to carry out one or more of the methods described herein.

In one aspect, an apparatus is described which includes at least one processor and at least one machine-readable medium storing executable instructions which when executed by the at least one processor configure the apparatus to carry out one or more of the methods described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 is an illustration of a physical layer protocol data unit (PPDU) format for the enhanced directional multi-gigabit (EDMG) format.

FIG. 2 is an illustration of an EDMG A-PPDU format.

FIG. 3 is an illustration of a multi-static sensing setup with one transmitter and three receivers, according to embodiments.

FIG. 4 is an illustration of a multi-static sounding PPDU structure.

FIG. 5 is an illustration of a MU EDMG A-PPDU format with a Data field, according to embodiments.

FIG. 6 is an illustration of another MU EDMG A-PPDU format with a Data field according to embodiments.

FIG. 7 is an illustration of a MU EDMG A-PPDU format without a Data field according to embodiments.

FIG. 8 is an illustration of another MU EDMG A-PPDU format without a Data field according to embodiments.

FIG. 9 is an illustration of a MU EDMG A-PPDU format with a Data field according to embodiments.

FIG. 10 is an illustration of another MU EDMG A-PPDU format without a Data field according to embodiments.

FIG. 11 is an illustration of an EDMG multi-static sensing PPDU format according to embodiments.

FIG. 12 is a schematic diagram of an electronic device that may perform any or all of operations of the above methods and features explicitly or implicitly described herein, according to different embodiments of the present disclosure.

It will be noted that throughout the appended drawings, like features are identified by like reference numerals.

### DETAILED DESCRIPTION

Embodiments of the present disclosure relate to the format of an enhanced directional multi-gigabit (EDMG as specified in the IEEE 802.11ay standard) physical layer protocol data unit (PPDU), and associated methods and apparatus. The PPDU can be used for example as a multi-user PPDU in data communications and/or a sounding PPDU in multi-static sensing operations.

Multi-static sensing is considered in IEEE 802.11bf standard for operations in the 60 GHz band. In multi-static sensing, a sounding PPDU structure has been proposed in which a single sounding PPDU is transmitted from the initiator to a multiple of responders. A training field for the sensing purposes is appended at the end of the PPDU and shared by the multiple receivers. There has been proposed a PPDU structure that is a type of multi-user PPDU.

In further detail, in the EDMG channel bonding mode (4.32 GHz, 6.48 GHz and 8.64 GHz EDMG PPDU transmissions), an EDMG PPDU is transmitted over more than one 2.16 GHz channel. In the EDMG channel bonding mode, the pre-EDMG modulated fields such as L-STF, L-CEF, and L-Header are to be transmitted using the pre-EDMG duplicate format over each 2.16 GHz. Synchronization and detection of an EDMG PPDU are based on reception of L-STF, L-CEF, and L-Header fields. However, this proposed EDMG multi-static sensing PPDU requires an EDMG multi-static sensing receiver to perform detection and synchronization of a PPDU directly using the Sync field transmitted over more than one 2.16 GHz channel. This forces an EDMG multi-static sensing receiver to operate by following another new receive procedure in addition to the EDMG receive procedure. For the reason of backward compatibility, this requires an EDMG multi-static sensing receiver be implemented to provide two different receiver procedures that increases the receiver complexity.

In addition, since in the EDMG multi-static PPDU format (as specified in reference document IEEE 802.11-22/0464r6, PDT EDMG multi-static PPDU structure), except for a first recipient STA (STA1) there is no PPDU length information to be transmitted. For example, different portions of the PPDU are transmitted to the corresponding STAs which can be in different directions when compared to STA1. Accordingly, it can be possible that legacy STAs that are not covered by a transmission in a direction destined for STA1, cannot receive the L-STF field, L-CEF field and L-Header field which is where Length field is located. Therefore, a legacy EDMG STA cannot synchronize the transmitted PPDU and does not know how long an EDMG multi-static PPDU lasts. This is another issue for coexistence.

According to embodiments, this instant disclosure generalizes a multi-user (MU) PPDU to MU EDMG A-PPDU in order to mitigate complexity and co-existence issues which can be solved by transmitting L-STF, L-CEF, L-Header and EDMG-Header-A for each of the STAs in the multi-user scenario. It will be readily understood that embodiments can be applied to both efficient EDMG data communications and sensing applications.

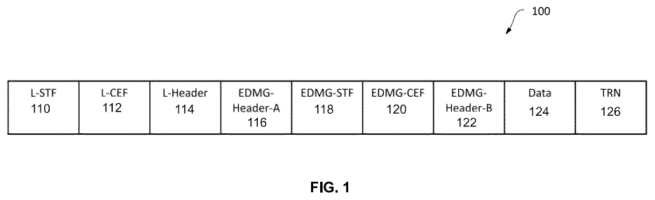

FIG. 1 is an illustration of a PPDU format 100 for the enhanced directional multi-gigabit (EDMG or IEEE 802.11ay) standard. EDMG multi-static sounding PPDUs may be based on the EDMG PPDU format 100 and include many of the same fields as described in the EDMG standard.

An EDMG PPDU may be transmitted on a 60 GHz band, a part of which is also recognized by the directional multi-gigabit (DMG or IEEE 802.11ad) devices. To enable backward compatibility, the first three fields 110, 112, 114 of the EDMG PPDU format 100, are defined to be recognizable by legacy DMG stations. The L-STF (legacy short training field) 110 and L-CEF (legacy channel estimation field) 112 are compatible with the preamble defined in IEEE 802.11ad. The L-STF field 110 allows discovery and synchronization of the EDMG/DMG packet, while the L-CEF field 112 enables channel estimation for demodulation of the L-Header field 114 and the EDMG-Header-A field 416. The L-Header field 114 contains information about the EDMG/DMG packet.

The EDMG-Header-A field 116 contains information for the EDMG PPDU. For 4.32 GHz, 6.48 GHz and 8.64 GHz EDMG PPDU transmissions, each of the first four fields 110, 112, 114, 116 of the EDMG PPDU may be transmitted in duplicate on each 2.16 GHz subchannel of the packet, as legacy devices may be configured to only use one subchannel. Each of the remaining fields of the EDMG PPDU may be transmitted on the full bandwidth of the packet, such as on a 4.32 GHz, 6.48 GHz, or 8.64 GHz channel.

The EDMG-STF field 118 allows synchronization of the EDMG PPDU. The EDMG-CEF field 120 allows channel estimation for demodulation of the EDMG-Header-B field 122 and data field 124. The EDMG-Header-B field 122 includes information for EDMG multi-user (MU) PPDUs. The data field 124 includes the payload data of the packet, padded with zeros if necessary for packaging. Finally, the PPDU format 100 includes a training (TRN) sequence field 126 which is used for beam forming training and beam tracking, as part of a beam refinement protocol (BRP) process to allow STAs to improve their antenna configuration for transmission and/or reception. The TRN field 126 may be composed of a plurality of TRN subfields, as described in the EDMG standard.

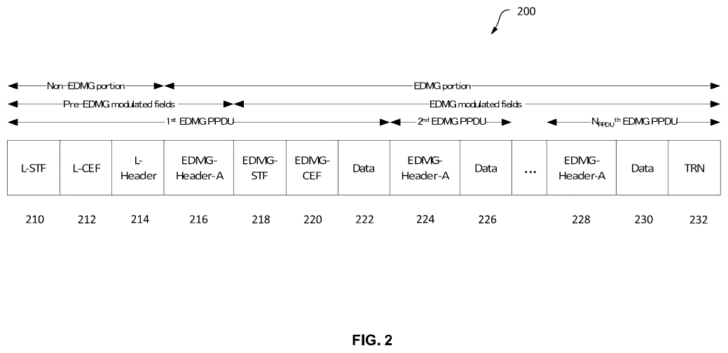

FIG. 2 is an illustration of an EDMG A-PPDU format 200 as defined by 802.11ay. It is understood that an EDMG A-PPDU of this format is, according to current standard specifications, to be transmitted to a single user (e.g. responder STA) and is not to be transmitted to multiple users. The first PPDU of an EDMG A-PPDU includes L-STF field 210, L-CEF field 212, L-Header field 214, EDMG-Header-A field 216, EDMG-STF field 218, EDMG-CEF field 220, and Data field 222. A-PPDU can be considered to be an efficient transmission method, in which L-STF field 210, L-CEF field 212, L-Header field 214, EDMG-Header A field 216, EDMG-STF field 218, EDMG-CEF field 220 field can be used by multiple PPDUs. Starting from the 2^{nd} PPDU, each subsequent PPDU includes EDMG-Header-A field and respective data field. For example, in FIG. 2, EDMG-Header-A field 224 is followed by the associated data field 226 and followed by the next EDMG-Header-A field 228 and associated Data field 230. The TRN field 232, if present, is appended only once at the end of an EDMG A-PPDU. It is noted that an advantage of EDMG A-PPDU can be considered to enable efficient transmissions for which multiple PPDUs share the same preamble and training fields. A drawback of the EDMG A-PPDU format in 802.11ay is that it can only be applied to single user (STA) PPDU transmission. It is noted that the physical layer (PHY) receive state machine for a single user (SU) EDMG PPDU reception (e.g NUM_STS=1, no TRN field), synchronization and detection of a PPDU starts upon the detection of L-STF 210.

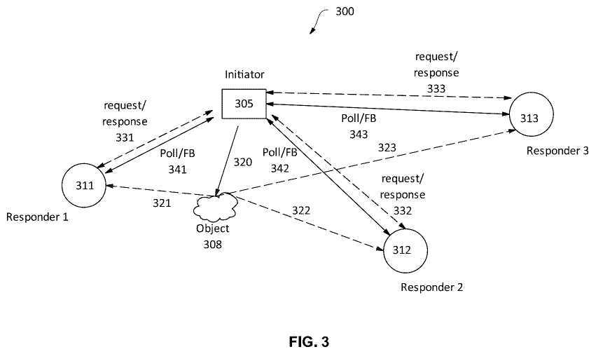

FIG. 3 illustrates a multi-static sensing setup 300 with one transmitter and three receivers, according to one aspect of the present disclosure. The transmitter and the receivers may each be STAs on a wireless communication network. The multi-static sensing setup 300 is illustrated with three receivers but may also be generalized to include more than three receivers.

In the multi-static sensing setup 300, the sensing initiator 305 (e.g. an access point (AP)) begins a sensing instance and acts as a transmitter with three sensing responders 311, 312, 313 acting as receivers. The sensing instance may be set up by an exchange of request and response 331 (handshakes) with the first responder 311, and a similar exchange of request and response 332 with the second responder 312, as well as a similar exchange of request and response 333 with the third responder 313.

The sensing instance may generally be directed towards detecting features of a given target, such as object 308. The sensing instance includes the sensing initiator 305 transmitting a sounding PPDU. A part of the signal 320, particularly one or more training (TRN) fields in the sounding PPDU, from the sensing initiator 305 may be transmitted from the sensing initiator 305 and strike the object 308. A part of this signal 321 may reflect off the object 308 and propagate towards the first responder 311, and a part of this signal 322 may reflect off the object 308 and propagate towards the second responder 312 and a part of this signal 322 may reflect off the object 308 and propagate towards the third responder 313. After the sensing initiator 305 transmits the sounding PPDU, each of the responders 311, 312, 313 may be polled and report feedback 341, 342, 343. The feedback 341, 342, 343 may be related to the part of the signal 321, 322, 323 which was received by the responders 311, 312 313 after it had reflected off the object 308. The feedback 341, 342, 343 may be used by the sensing initiator 305 to detect features of the object 308.

The multi-static sensing setup 300 includes a sensing initiator 305 which also acts as the transmitter during the sounding phase of the sensing instance.

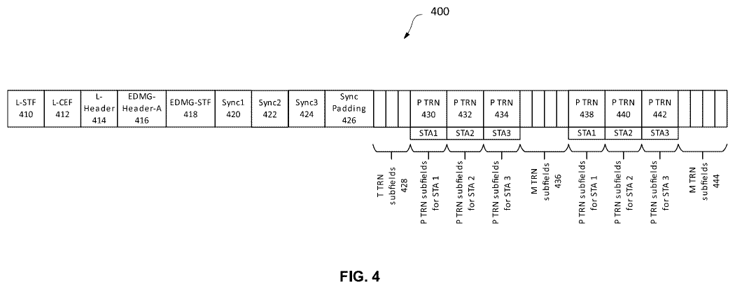

FIG. 4 is an illustration of a multi-static sounding PPDU structure 400 which has been proposed. The illustrated PPDU structure considers there to be three receiver or responder STAs (for example as shown in FIG. 3). Here and elsewhere herein, the number of STAs associated with a PPDU can be three, more than three, or fewer than three (e.g. two). The PPDU structure includes L-STF field 410, L-CEF field 412, L-Header field 414, EDMG-Header A field 416 and EDMG-STF field 418.

EDMG Multi-static sensing PPDU structure illustrated in FIG. 4 allows PPDU transmission from one transmitter to multi-static sensing receivers that share the same training field (T TRN 428). P TRN subfields 430, 432, 434 are transmitted in different directions and may be received by multi-static sensing receivers (e.g. STA1, STA2 and STA3 in this illustration. As will be readily understood by a person skilled in the art, different portions of a PPDU can be transmitted in different directions (i.e. directionally transmitted) toward different STAs, for example by use of beamforming or directional antenna switching techniques. Each multi-static sensing STA (receiver) is synchronized with a respective Sync field 420, 422, 424 transmitted in a multi-static sensing PPDU, which is an EDMG modulated field. For example, STA1 is associated with Sync 1 420, STA2 is associated with Sync 422 and STA3 is associated with Sync3 424. Subsequent, to the transmission of the first P TRN field to each of the respective STAs, M TRN field 436 is transmitted. This field is followed by the retransmission of the P TRN fields for each of the respective STAs (438, 440, 442) and a repeat of the M TRN field 444.

In the EDMG channel bonding mode, i.e., 4.32 GHz, 6.48 GHz and 8.64 GHz EDMG PPDU transmissions, a Sync field is transmitted using wideband signals. This form of transmission requires a receiver (e.g. STA) to perform synchronization over the wideband, which is different from the EDMG receive procedure that is currently specified in the 802.11ay.

There are potential issues with the multi-static sensing PPDU structure illustrated in FIG. 4. Based on the current or legacy EDMG receive procedure, an EDMG receiver is specified to start the detection of a PPDU by receiving the transmitted PHY preamble over the primary 2.16 GHz channel, namely the receipt of L-STF field 410, L-CEF field 412, L-Header field 414 and the EDMG-Header A field 416. Since backward compatibility is a requirement for a STA configured according to 802.11bf, this backward compatibility requires that an EDMG multi-static sensing STA is to implement two different receiver procedures in order to perform synchronization of a PPDU over the primary 2.16 GHz bands and a wide band, respectively.

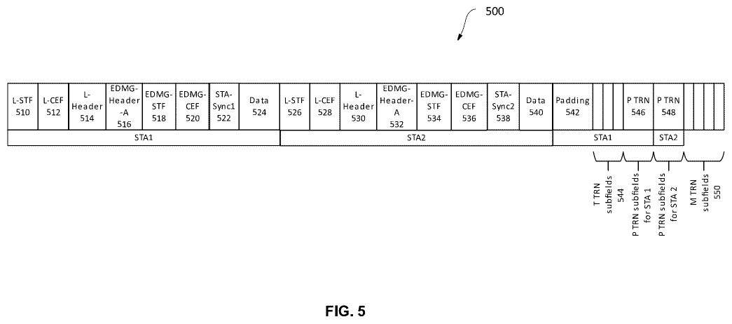

To mitigate the above potential issues, or more generally to provide for alternative approaches to communication and sensing, embodiments of the present disclosure provide for various PPDU formats as detailed below. A device such as an AP can generate and transmit such formatted PPDUs. Such PPDUs may be characterized as MU EDMG A-PPDUs, which are destined for multiple recipients, and which include multiple concatenated parts for use by the multiple recipients. For sensing (or other) purposes, training fields at the end of the PPDU can include different training fields for use by different recipients. By way of example, the PPDUs of FIGS. 5 to 10 specify fields corresponding to two different recipients (STA1 and STA2), however such PPDUs can be expanded to specify similar fields corresponding to additional recipients. Fields corresponding to a particular recipient may be directionally transmitted toward that recipient.

According to various embodiments, for each intended recipient STA toward which a part of a PPDU is directionally transmitted, the PPDU includes a copy of the legacy (DMG) header, or at least some fields thereof. Because of this, and in receipt of these fields, a recipient STA can perform required operations, such as synchronizations, without necessarily requiring a separate wideband (e.g. EDMG) procedure.

For example, according to various embodiments, a method and associated apparatus are provided. A device generates a PPDU having a plurality of legacy fields (i.e. fields originally specified for IEEE directional multigigabit (DMG)), such as but not necessarily limited to the legacy short training field (L-STF), legacy channel estimation field (L-CEF) and L-Header. In some embodiments, L-CEF may aid with performing fine PPDU synchronization. In some embodiments L-Header can include a Length field that can be used to estimate the PPDU duration. Each of the plurality of legacy fields corresponds to a different recipient STA. The device then transmits the PPDU such that different portions of the PPDU are directionally transmitted toward a different one of the recipient STAs. Each of these different portions includes a different one of the plurality of legacy fields. As will be understood, legacy fields are modulated using legacy, pre-EDMG modulation formats. For example, legacy fields may be modulated using DMG modulation formats.

Each of the embodiments as illustrated in FIGS. 5 to 10 represent a particular example of the above-described embodiment, with the PPDUs thereof including plural legacy fields L-STF, L-CEF and L-Header. Furthermore, and similarly, each of the embodiments as illustrated in FIGS. 5 to 10 includes plural instances of the EDMG-Header-A field, plural instances of the EDMG-STF field, and in some cases, plural instances of the EDMG-CEF field. Each of these instances is also directionally transmitted toward a different recipient STA. Other fields may be provided similarly, as described elsewhere hercin.

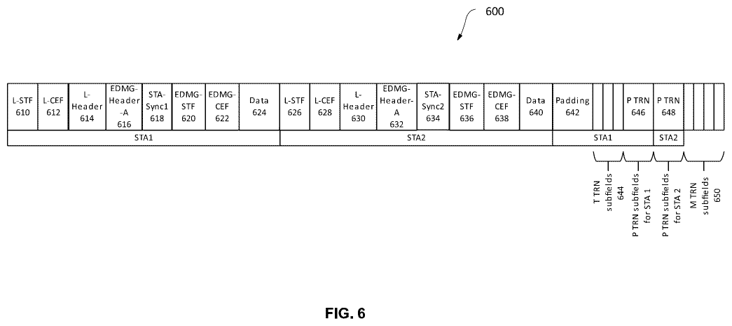

FIG. 5 illustrates a PPDU format provided in accordance with some embodiments. FIG. 6 is an illustration of another MU EDMG A-PPDU format with a Data field according to embodiments. The PPDU format includes a first contiguous portion which includes a first contiguous sub-portion including a first legacy short training field (L-STF) 510, 610 a first legacy channel estimation field (L-CEF) 512, 612 a first legacy header field (L-Header) 514, 614, and a first enhanced directional multi-gigabit (EDMG) header-A field (EDMG-Header-A) 516, 616. In the embodiment illustrated in FIG. 6, the first contiguous sub-portion further includes a first synchronization field 618 specific to a first STA. The first contiguous portion further includes second contiguous sub-portion including a first EDMG short training field (EDMG-STF) 518, 620, a first EDMG channel estimation field (EDMG-CEF) 520, 622, a first data portion field 524, 624 and a first synchronization field specific to a first station (STA) 522, namely for the embodiment illustrated in FIG. 5. The second contiguous portion includes a third contiguous sub-portion including a second L-STF 526, 626, a second L-CEF 528, 628, a second L-Header 530, 630, and a second EDMG-Header-A 532, 632. In the embodiment illustrated in FIG. 6, the third contiguous sub-portion further includes a second synchronization field 634 specific to a second STA. The second contiguous portion further includes a fourth contiguous sub-portion including a second EDMG-STF 534, 636, a second EDMG-CEF 536, 638, a second data portion field 540, 640 and a second synchronization field specific to a second station (STA) 538, namely for the embodiment illustrated in FIG. 5.

In some embodiments, the PPDU further includes a padding field 542, 642 modulated using the EDMG format and located after the second contiguous portion, the padding field directionally transmitted toward the first STA. In some embodiments the PPDU further includes a first one or more training subfields 546, 646 directionally transmitted toward the first STA and a second one or more training subfields 548, 648, directionally transmitted toward the second STA.

According to embodiments, having further regard to FIG. 5, L-STF, 510, 526, L-CEF, 512, 528, L-Header, 514, 530, EDMG-Header A, 516, 532 are defined and transmitted as specified in EDMG, namely pre-EDMG modulated. EDMG-STF, 518, 534, EDMG-CEF, 520, 536, data field, 524, 540, and TRN subfields, 544, 546, 548, 550 are defined and transmitted as specified in EDMG, namely EDMG modulated. STA Sync 1, 522, STA Sync2 538, and Padding fields 542 are also EDMG modulated.

According to embodiments, a potential advantage of the embodiment illustrated in FIG. 5 is that this MU EDMG A-PPDU format may include efficient transmission multiple PPDUs for multiple STAs, synchronization and detection of PPDUs specified in the EDMG receive procedure can be reused. In addition, additional STA synchronization using Sync field is for a specific STA to identify the portion of MU EDMG A-PPDU transmitted to that STA. An additional potential benefit relates to the coexistence with legacy EDMG STAs.

According to embodiments, having further regard to FIG. 6, L-STF, 610, 626, L-CEF, 612, 628, L-Header, 614, 630, EDMG-Header A, 616, 632 are defined and transmitted as specified in EDMG, namely pre-EDMG modulated. STA Sync 1, 618, STA Sync 2 634, are also pre-EDMG modulated. EDMG-STF, 620, 636, EDMG-CEF, 622, 638, Data, 624, 640, and TRN subfields, 644, 646, 648, 650 are defined and transmitted as specified in EDMG, namely EDMG modulated. Padding fields 642 is also EDMG modulated. It is noted that in the embodiment illustrated in FIG. 6, when compared to the embodiment illustrated in FIG. 5, the STA Sync I, 618, STA Sync 2 634 fields have been moved to be proximate their respective EDMG-Header A field, 616, 632 respectively.

According to embodiments, a potential benefit of the MU EDMG A-PPDU format illustrated in FIG. 6 is that there is a consideration that the STA synchronization operation can be performed over one 2.16 GHz channel, which may reduce implementation complexity.

According to embodiments, STA Sync i includes an orthogonal sequence assigned specifically for STA i. For example, a set of orthogonal sequences are sequences having the good autocorrelation property and orthogonal pairwise cross-correlation property. In some embodiments, another sequence may be allocated prior to the orthogonal sequence in time for implementation consideration of a delay of EDMG-Header-A decoding.

According to embodiments, each EDMG-Header-A field for a specific STA includes an indication bit to indicate MU EDMG A-PPDU. In some embodiments, a PHY layer service data unit (PSDU) Length field defined in the EDMG-Header-A for a specific STA can indicate the length of STA-Sync+Data fields for the corresponding STA in the MU EDMG A-PPDU. In some embodiments, the Length field and the Training Length field can be defined in the L-Header, the Length field together with the Training Length field can be set to estimate the whole PPDU duration.

According to embodiments, there is provided a method including generating, by a device, a physical layer (PHY) protocol data unit (PPDU). The PPDU includes a first contiguous portion and a second contiguous portion. The first contiguous portion includes a first contiguous sub-portion including a first legacy short training field (L-STF), a first legacy channel estimation field (L-CEF), a first legacy header (L-Header), and a first enhanced directional multi-gigabit (EDMG) header-A (EDMG-Header-A). The first contiguous portion further includes second contiguous sub-portion including a first EDMG short training field (EDMG-STF), a first EDMG channel estimation field (EDMG-CEF), and optionally a first data portion. The first contiguous portion further including a first synchronization field specific to a first station (STA). The second contiguous portion includes a third contiguous sub-portion including a second L-STF, a second L-CEF, a second L-Header, and a second EDMG-Header-A. The second contiguous portion further includes a fourth contiguous sub-portion including a second EDMG-STF, a second EDMG-CEF, and optionally a second data portion. The second contiguous portion further including a second synchronization field specific to a second station (STA).

The method further includes transmitting, by the device, the PPDU, with the first contiguous portion directionally transmitted toward the first STA and the second contiguous portion directionally transmitted toward the second STA. The first contiguous sub-portion and the third contiguous sub-portion modulated using a legacy, pre-EDMG modulation format. The second contiguous sub-portion and the fourth contiguous sub-portion modulated using an EDMG modulation format. In addition, either the first synchronization field is included in the first contiguous sub-portion and the second synchronization field is included in the third contiguous sub-portion or the first synchronization field is included in the second contiguous sub-portion and the second synchronization field is included in the fourth contiguous sub-portion.

In some embodiments, the PPDU further includes a padding field 542 modulated using the EDMG format and located after the second contiguous portion, the padding field directionally transmitted toward the first STA. In some embodiments the PPDU further comprises a first one or more training subfields 546 directionally transmitted toward the first STA and a second one or more training subfields 548 directionally transmitted toward the second STA.

In some embodiments, the first synchronization subfield includes a first sequence selected from a set of orthogonal sequences, the first sequence assigned to the first STA, or the second synchronization subfield includes a second sequence selected from the set of orthogonal sequences, the second sequence assigned to the second STA, or both. In some embodiments, the first synchronization subfield further includes another first sequence allocated prior to the first orthogonal sequence in time to facilitate implementation of a delay of decoding of the first EDMG-Header-A, or the second synchronization subfield further includes another second sequence allocated prior to the second orthogonal sequence in time to facilitate implementation of a delay of decoding of the second EDMG-Header-A.

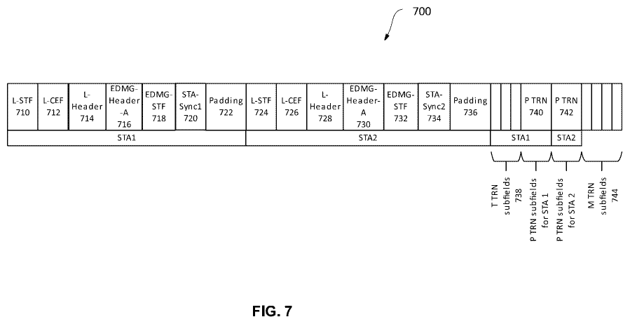

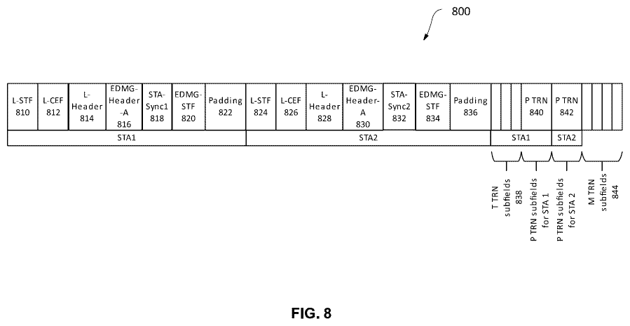

FIG. 7 is an illustration of a MU EDMG A-PPDU format without a Data field according to embodiments. FIG. 8 is an illustration of another MU EDMG A-PPDU format without a Data field according to embodiments. The PPDU format includes a first contiguous portion which includes a first contiguous sub-portion including a first legacy short training field (L-STF) 710, 810 a first legacy channel estimation field (L-CEF) 712, 812 a first legacy header field (L-Header) 714, 814, and a first enhanced directional multi-gigabit (EDMG) header-A field (EDMG-Header-A) 716, 816. It is noted that this PPDU format neither includes EDMG-CEF fields nor data fields. The first contiguous portion further includes second contiguous sub-portion including a first EDMG short training field (EDMG-STF) 718, 820 and a first synchronization field specific to a first station (STA) 720, 818. The second contiguous portion includes a third contiguous sub-portion including a second L-STF 724, 824, a second L-CEF 726, 826, a second L-Header 728, 828, and a second EDMG-Header-A 730, 830. The second contiguous portion further includes a fourth contiguous sub-portion including a second EDMG-STF 732, 834, and a second synchronization field specific to a second station (STA) 538, 634.

In some embodiments, the PPDU further includes a first padding field 722, 822 modulated using the EDMG format and located after the first contiguous portion, the padding field directionally transmitted toward the first STA. In some embodiments, the PPDU further includes a second padding field 736, 836 modulated using the EDMG format and located after the second contiguous portion, the padding field directionally transmitted toward the second STA. In some embodiments the PPDU further includes a first one or more training subfields 740, 840 directionally transmitted toward the first STA and a second one or more training subfields 742, 842, directionally transmitted toward the second STA.

According to embodiments, having further regard to FIG. 7, L-STF, 710, 724, L-CEF, 712, 726, L-Header, 714, 728, EDMG-Header A, 716, 730 are defined and transmitted as specified in EDMG, namely pre-EDMG modulated. EDMG-STF, 718, 732, padding field, 722, 736, and TRN subfields, 738, 740, 742, 744 are defined and transmitted as specified in EDMG, namely EDMG modulated. STA Sync I, 720, STA Sync2 734 are also EDMG modulated.

According to embodiments, a potential advantage of the embodiment illustrated in FIG. 7 is that this the MU EDMG A-PPDU format does not include EDMG-CEF and data fields for more efficient sensing applications in which data field include only dummy bits in general. The EDMG-CEF field can also be removed from a PPDU since it is used for detection of data in the Data field.

According to embodiments, having further regard to FIG. 8, L-STF, 810, 824, L-CEF, 812, 826, L-Header, 814, 828, EDMG-Header A, 816, 830 are defined and transmitted as specified in EDMG, namely pre-EDMG modulated. EDMG-STF, 820, 834, and TRN subfields, 838, 840, 842, 844 are defined and transmitted as specified in EDMG, namely EDMG modulated. STA Sync I, 818, STA Sync 2 832 are pre-EDMG modulated. Padding fields 822, 836 are EDMG modulated. It is noted that in the embodiment illustrated in FIG. 8, when compared to the embodiment illustrated in FIG. 7, the STA Sync 1, 818, STA Sync 2 832 fields have been moved to be proximate their respective EDMG-Header A field, 816, 830 respectively.

According to embodiments, a potential benefit of the MU EDMG A-PPDU format illustrated in FIG. 8 may be considered to be at least similar to those as presented elsewhere herein with respect to PPDU format as discussed in relation to FIG. 6 and FIG. 7.

According to embodiments, STA Sync i includes an orthogonal sequence assigned specifically for STA i. For example, a set of orthogonal sequences are sequences having the good autocorrelation property and orthogonal pairwise cross-correlation property. In some embodiments, another sequence may be allocated prior to the orthogonal sequence in time for implementation consideration of a delay of EDMG-Header-A decoding.

According to embodiments, each EDMG-Header-A field for a specific STA includes an indication bit to indicate MU EDMG A-PPDU. In some embodiments, a PHY layer service data unit (PSDU) Length field defined in the EDMG-Header-A for a specific STA can indicate the length of STA-Sync+padding fields for the corresponding STA in the MU EDMG A-PPDU by taking into account the removal of the EDMG-CEF. In some embodiments, the Length field can be defined in the L-Header and the Training Length field can be defined in the L-Header, the Length field together with the Training Length field can be set to estimate the whole PPDU duration.

According to embodiments, there is provided a method including generating, by a device, a physical layer (PHY) protocol data unit (PPDU). The PPDU includes a first contiguous portion and a second contiguous portion. The first contiguous portion includes a first contiguous sub-portion including a first legacy short training field (L-STF), a first legacy channel estimation field (L-CEF), a first legacy header (L-Header), and a first enhanced directional multi-gigabit (EDMG) header-A (EDMG-Header-A). The first contiguous portion further includes a second contiguous sub-portion including a first EDMG short training field (EDMG-STF) and a first synchronization field specific to a first station (STA). The second contiguous portion includes a third contiguous sub-portion including a second L-STF, a second L-CEF, a second L-Header, and a second EDMG-Header-A. The second contiguous portion further includes a fourth contiguous sub-portion including a second EDMG-STF and a second synchronization field specific to a second station (STA). The method further includes transmitting, by the device, the PPDU, with the first contiguous portion directionally transmitted toward the first STA and the second contiguous portion directionally transmitted toward the second STA. The first contiguous sub-portion and the third contiguous sub-portion are modulated using a legacy, pre-EDMG modulation format. The second contiguous sub-portion and the fourth contiguous sub-portion are modulated using an EDMG modulation format. In addition, either the first synchronization field is included in the first contiguous sub-portion and the second synchronization field is included in the third contiguous sub-portion or the first synchronization field is included in the second contiguous sub-portion and the second synchronization field is included in the fourth contiguous sub-portion.

According to embodiments, the second contiguous sub-portion includes a first padding field, or the fourth contiguous sub-portion includes a second padding field, or both. According to embodiments, the PPDU further comprises a first one or more training subfields directionally transmitted toward the first STA and a second one or more training subfields directionally transmitted toward the second STA.

According to embodiments, the first synchronization subfield includes a first sequence selected from a set of orthogonal sequences, the first sequence assigned to the first STA, or the second synchronization subfield includes a second sequence selected from the set of orthogonal sequences, the second sequence assigned to the second STA, or both. According to embodiments, the first synchronization subfield further includes another first sequence allocated prior to the first orthogonal sequence in time to facilitate implementation of a delay of decoding of the first EDMG-Header-A, or the second synchronization subfield further includes another second sequence allocated prior to the second orthogonal sequence in time to facilitate implementation of a delay of decoding of the second EDMG-Header-A, or both.

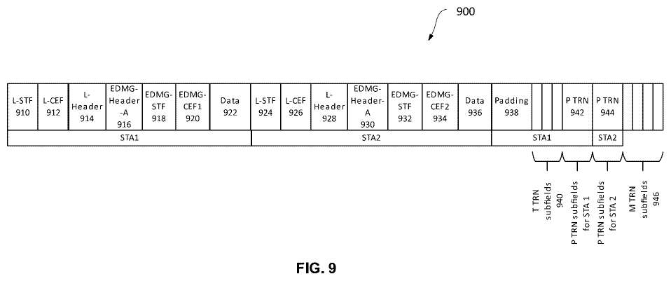

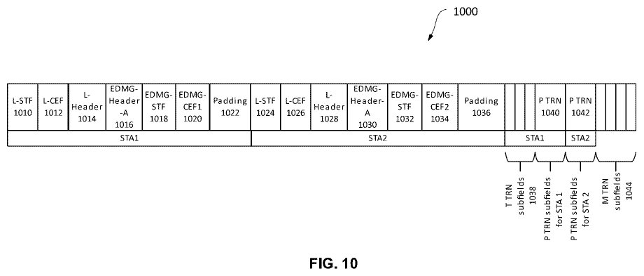

FIG. 9 is an illustration of a MU EDMG A-PPDU format with a Data field according to embodiments. FIG. 10 is an illustration of another MU EDMG A-PPDU format without a Data field according to embodiments. The PPDU format includes a first contiguous portion which includes a first contiguous sub-portion including a first legacy short training field (L-STF) 910, 1010, a first legacy channel estimation field (L-CEF) 912, 1012, a first legacy header field (L-Header) 914, 1014, and a first enhanced directional multi-gigabit (EDMG) header-A field (EDMG-Header-A) 916, 1016. The first contiguous portion further includes second contiguous sub-portion including a first EDMG short training field (EDMG-STF) 918, 1018 and an EDMG channel estimation field 1 (EDMG-CEF 1) 920, 1020. For the embodiment illustrated in FIG. 9 the first contiguous portion further includes and a first data portion field 922. For the embodiment illustrated in FIG. 10 the first contiguous portion further includes a padding field 1022. The second contiguous portion includes a third contiguous sub-portion including a second L-STF 924, 1024, a second L-CEF 926, 1026, a second L-Header 928, 1028, and a second EDMG-Header-A 930, 1030. The second contiguous portion further includes a fourth contiguous sub-portion including a second EDMG-STF 932, 1032 and an EDMG-CEF 2 934, 1034. For the embodiment illustrated in FIG. 9 the second contiguous portion further includes and a second data portion field 936. For the embodiment illustrated in FIG. 10 the second contiguous portion further includes a padding field 1036.

In some embodiments the PPDU further includes a first one or more training subfields 940, 942, 1038, 1040 directionally transmitted toward the first STA and a second one or more training subfields 944, 1042 directionally transmitted toward the second STA. For the embodiment illustrated in FIG. 9 the second contiguous portion further includes a padding field 938 directionally transmitted toward the first STA.

According to embodiments, having further regard to FIGS. 9 and 10, L-STF, 910, 924, 1010, 1024 L-CEF, 912, 926, 1012, 1026, L-Header, 914, 928, 1014, 1028, EDMG-Header A, 916, 930, 1016, 1030 are defined and transmitted as specified in EDMG, namely pre-EDMG modulated. EDMG-STF, 918, 932, 1018, 1032, EDMG-CEF 1, 920, 1020 EDMG-CEF 2 934, 1034 and TRN subfields, 940, 942, 944, 946, 1038, 1040, 1042, 1044 are defined and transmitted as specified in EDMG, namely EDMG modulated. With reference to FIG. 9, the data fields 922, 936 and the padding field 938 are also defined and transmitted as specified in EDMG, namely EDMG modulated. With reference to FIG. 10, the padding fields 1022, 1036 are also defined and transmitted as specified in EDMG, namely EDMG modulated.

According to embodiments, EDMG-CEF i is one of EDMG-CEF specified in EDMG and assigned specifically for STA i. For example, with reference to FIGS. 9 and 10, EDMG-CEF 1 is associated with STA1, while EDMG-CEF 2 is associated with STA2. It is noted that EDMG-CEF i and EDMG-CEF j can be selected from a set of EDMG-CEFs specified in EDMG, wherein the sequences hold a good autocorrelation property and can be orthogonal in terms of mutual cross-correlations.

According to embodiments, each EDMG-Header-A field for a specific STA includes an indication bit to indicate MU EDMG A-PPDU. In some embodiments, a PHY layer service data unit (PSDU) Length field defined in the EDMG-Header-A for a specific STA can indicate the length of the data field (in the case of FIG. 9) or the padding field with consideration of the removal of the EDMG-CEF field (in the case of FIG. 10) for the same STA in the MU EDMG A-PPDU. In some embodiments, the Length field and the Training Length field can be defined in the L-Header, the Length field together with the Training Length field can be set to estimate the whole PPDU duration.

According to embodiments, a potential advantage of the embodiments illustrated in FIGS. 9 and 10 is the use of EDMG-CEF i to replace a Sync field associated with STAi. The receiving process associated with the EDMG-CEF in EDMG can be reused.

According to embodiments, there is provided a method including generating, by a device, a physical layer (PHY) protocol data unit (PPDU). The PPDU includes a first contiguous portion and a second contiguous portion. The first contiguous portion includes a first contiguous sub-portion including a first legacy short training field (L-STF), a first legacy channel estimation field (L-CEF), a first legacy header (L-Header), and a first enhanced directional multi-gigabit (EDMG) header-A (EDMG-Header-A). The first contiguous portion further includes a second contiguous sub-portion including a first EDMG short training field (EDMG-STF), and a first EDMG channel estimation field (EDMG-CEF), wherein the first EDMG-CEF is specific to a first station (STA). The second contiguous portion includes a third contiguous sub-portion including a second L-STF, a second L-CEF, a second L-Header, and a second EDMG-Header-A. The second contiguous portion further includes a fourth contiguous sub-portion including a second EDMG-STF, and a second EDMG-CEF different from the first EDMG-CEF, wherein the second EDMG-CEF is specific to a second station (STA). The method further includes transmitting, by the device, the PPDU, with the first contiguous portion directionally transmitted toward the first STA and the second contiguous portion directionally transmitted toward the second STA. The first contiguous sub-portion and the third contiguous sub-portion are modulated using a legacy, pre-EDMG modulation format. The second contiguous sub-portion and the fourth contiguous sub-portion are modulated using an EDMG modulation format.

According to some embodiments, the PPDU further includes a padding field modulated using the EDMG format and located after the second contiguous portion, the padding field directionally transmitted toward the first STA. According to embodiments, the second contiguous sub-portion includes a first data portion, or the fourth contiguous sub-portion includes a second data portion, or both. In some embodiments, the second contiguous sub-portion includes a first padding field, or the fourth contiguous sub-portion includes a second padding field, or both.

In some embodiments, the first EDMG-CEF includes a first orthogonal sequence selected from a set of EDMG-CEFs assigned to the first STA, or the second EDMG-CEF includes a second orthogonal sequence selected from the same set of EDMG-CEFs assigned to the second STA, or both. In some embodiments, the first EDMG-CEF, the second EDMG-CEF, or both, are also used to facilitate channel estimation.

According to various embodiments, one or more set-up operations are performed, for example in advance of transmission of one of the above-described PPDUs. The set-up operations can involve discovering or communicating MU EDMG A-PPDU capabilities of devices. The set-up operations can further involve assigning Sync or EDMG-CEF field contents to devices (STAs).

In some such embodiments, device capabilities, such as MU EDMG A-PPDU capabilities, are exchanged via an EDMG Capability element carried in a frame such as an IEEE 802.11 Beacon frame, Probe Request frame, or Probe Response frame. The exchange may involve a one-way, two-way or multi-way exchange of information between two or more devices.

Accordingly, therefore, embodiments may involve communicating between devices (e.g. APs, STAs, or a combination thereof) to determine multi-user (MU), enhanced directional multi-gigabit (EDMG), aggregated physical layer (PHY) protocol data unit (A-PPDU) capabilities; and generating a PPDU, for example as described elsewhere herein, in accordance with said determined MU A-PPDU capabilities. The PPDU may be used for multi-static sensing.

As described elsewhere herein, for example with respect to FIGS. 7 and 8, a PPDU can include one, two or more synchronization fields (720, 734, 818, 832) specific to different STAs. Also as described elsewhere herein, for example with respect to FIGS. 9 and 10, a PPDU can include one, two or more EDMG-CEF fields (920, 932, 1020, 1032) specific to different STAs. These fields can be used both for pre-existing synchronization or channel estimation purposes, as well as for an additional identification purpose. The identification purpose can involve identifying that a portion of a PPDU, associated with the field, is intended for receipt by a particular STA. If the field includes a value which is specific (via pre-assignment) to a given STA, then the given STA (or another device having the information) can conclude, upon reading the value, that the associated portion of the PPDU is intended for receipt by the given STA. Notably, orthogonality properties of values can be used to facilitate such identification. The presently described embodiment can involve, via pre-communication and configuration, the necessary pre-assignment to support such functionality of identification.

Accordingly, in embodiments, Sync i or an EDMG-CEF i value is negotiated between the initiator and the responder STA i and assigned to the responder STA i during an association or sensing measurement setup phase, before the sensing measurement phase where an associated MU EDMG A-PPDUs are transmitted.

In more detail, in some embodiments a PPDU will include at least one synchronization field, at least one EDMG channel estimation field (EDMG-CEF), or both. Such a field is specific to a STA to which said at least one SYNC field, at least one EDMG channel estimation field (EDMG-CEF), or both is directionally transmitted. The field can be used for identification purposes by a recipient STA. In such embodiments, when communicating between devices to exchange device capabilities, or at a subsequent time prior to transmitting the PPDU, a set-up operation can occur. In the set-up operation, values are determined for each relevant SYNC

According to embodiments, the method further includes, during said communicating between the two or more devices or at a subsequent time prior to generating the PPDU, values can be determined for each relevant SYNC field, EDMG-CEF, or both. The values can be determined during an association or sensing measurement setup phase, for example. These determined values, when used in the PPDU, cause the SYNC field or EDMG-CEF, or both, to be specific to an associated STA. Accordingly, devices such as potential transmitters (e.g. APs) and potential recipients (e.g. STAs) of a PPDU can be pre-configured with one or more particular values identifying particular STAs, and these values can be used in the above-mentioned fields to identify that a portion of the PPDU is intended for a particular STA.

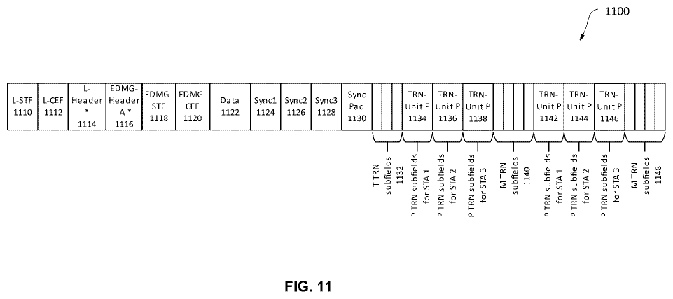

Embodiments of the present disclosure pertain to a PPDU such as a multi-static sensing sounding PPDU as illustrated in FIGS. 4 and 11. In particular, certain fields of such a PPDU are configured to indicate certain lengths, as described below. It is noted that the PPDU in FIG. 4 excludes data fields, whereas the PPDU in FIG. 11 includes a data field. A data field may be excluded in various embodiments for example when the PPDU is being used for multi-static sensing (sounding) and no data is required. A data field may be included for example when the PPDU is being used for multi-static sensing or other purposes. The multi-static sensing PPDU, without the presently described reconfiguration, is described for example in reference IEEE 802.11-22/781r2, Changes in EDMG Multistatic PPDU.

According to such embodiments, the length of a Data field (if present) of the PPDU and the length of synchronization (SYNC) fields may be indicated using a PHY layer service data unit (PSDU) Length field which is present in EDMG-Header A of the PPDU. The length of a synchronization pad (SYNC Pad) field may also be included in this indication.

In various such embodiments, the PSDU Length field defined in the EDMG-Header-A as defined in the IEEE 802.11ay standard, for a specific STA, can indicate the total overall lengths (as a sum) of the Data, Sync and Sync Pad fields. The value of the real PSDU length of PSDU data can be calculated from the value specified in the PSDU Length field and should be non-negative.

Accordingly, and with reference to FIG. 11, when the PPDU includes a data field 1122, the PSDU field of EDMG-Header-A 1116 may be set to specify a total length of: the data field 1122, plus each one of the one or more SYNC fields 1124, 1126, 1128, plus the SYNC Pad field 1130.

Similarly, and with reference to FIG. 4, when the PPDU excludes (does not include) a data field, the PSDU field of EDMG-Header-A 416 may be set to specify a total length of: each one of the one or more SYNC fields 420, 422, 424, plus the SYNC Pad field 426.

It is noted that in reference document IEEE 802.11-22/0464r6, PDT EDMG multi-static PPDU structure, “PSDU Length” field defined in the EDMG-Header-A for a specific STA can indicate the length of Sync+Sync Pad fields with consideration of the removal of EDMG-CEF field. In EDMG, EDMG-CEF is present and followed by Data field. The PSDU Length indicates the length of the field located after EDMG-CEF and before the TRN field. In embodiments, as illustrated in FIG. 4, EDMG-CEF is removed, and therefore, in this embodiment, the length of fields (Sync+Sync Pad) equals the length EDMG-CEF+PSDU Length.

In some further embodiments, the Length field together with Training Length field both defined in the L-Header (e.g. 414 or 1114) can be configured to indicate the total PPDU duration.

As also described elsewhere, the PPDU can be transmitted such that at least two different portions are directionally transmitted toward at least two different respective STAs.

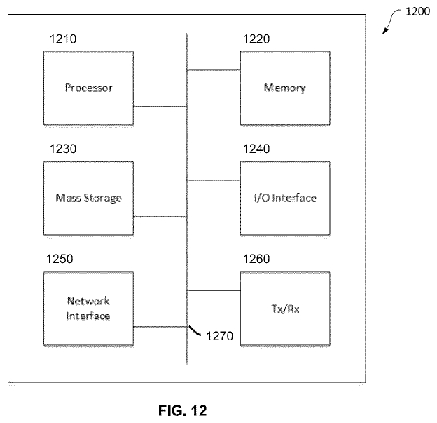

FIG. 12 is a schematic diagram of an electronic device 1200 that may perform any or all of operations of the above methods and features explicitly or implicitly described herein, according to different embodiments of the present disclosure. For example, a computer equipped with network functions may be configured as electronic device 1200. In some embodiments, the electronic device 1200 may be a user equipment (UE), an AP, a STA, or the like as appreciated by a person skilled in the art. The AP (or STA) can operate to transmit or receive a PPDU as described herein, for example in support of multi-static sensing.

As shown, the electronic device 1200 may include a processor 1210, such as a central processing unit (CPU) or specialized processors such as a graphics processing unit (GPU) or other such processor unit, memory 1220, non-transitory mass storage 1230, input-output interface 1240, network interface 1250, and a transceiver 1260, all of which are communicatively coupled via bi-directional bus 1270. According to certain embodiments, any or all the depicted elements may be utilized, or only a subset of the elements. Further, electronic device 1200 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1220 may include any type of non-transitory memory such as static random-access memory (SRAM), dynamic random-access memory (DRAM), synchronous DRAM (SDRAM), read-only memory (ROM), any combination of such, or the like. The mass storage clement 1230 may include any type of non-transitory storage device, such as a solid-state drive, hard disk drive, a magnetic disk drive, an optical disk drive, USB drive, or any computer program product configured to store data and machine executable program code. According to certain embodiments, the memory 1220 or mass storage 1230 may have recorded thereon statements and instructions executable by the processor 1210 for performing any of the method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, personal digital assistant (PDA), or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes instructions that enable a computer device (personal computer, server, or network device) to execute the methods provided in the embodiments of the present disclosure. For example, such an execution may correspond to a simulation of the logical operations as described herein. The software product may additionally or alternatively include instructions that enable a computer device to execute operations for configuring or programming a digital logic apparatus in accordance with embodiments of the present disclosure.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any modifications, variations, combinations, or equivalents that fall within the scope of the present invention.

1. A method comprising:
generating, by a device, a physical layer (PHY) protocol data unit (PPDU), the PPDU being formatted for use in multi-static sensing, the PPDU comprising:
two or more synchronization (SYNC) fields;
a synchronization pad (SYNC Pad) field;
if the PPDU includes a data field: in an enhanced directional multi-gigabit (EDMG)-Header-A, a PHY service data unit (PSDU) Length field set to specify a total length of: the data field, plus each one of the one or more SYNC fields, plus the SYNC Pad field; and
if the PPDU excludes the data field: in the enhanced directional multi-gigabit (EDMG)-Header-A, the PHY service data unit (PSDU) Length field set to specify a total length of: each one of the two or more SYNC fields, plus the SYNC Pad field; and
transmitting, by the device, the PPDU, such that at least two different portions of the PPDU are directionally transmitted toward different respective stations (STAs).

2. The method of claim 1, further comprising, by a recipient of the PPDU, calculating a length of PSDU data based on contents of the PSDU Length field in EDMG-Header-A.

3. The method of claim 1, wherein the PPDU further comprises a Length field and a Training Length field within a legacy header (L-Header) of the PPDU, the Length field set to specify a total length of all fields of the PPDU from the EDMG-Header-A to the SYNC Pad field, and inclusive of the EDMG-Header-A and the SYNC Pad field, the Length field together with Training Length field set to estimate the whole PPDU duration.

4. The method of claim 3, further comprising, by a recipient of the PPDU, calculating a length of PSDU data based on contents of the PSDU Length field in EDMG-Header-A.

5. The method of claim 1, wherein the PPDU is an aggregated multi-user PPDU (A-PPDU).

6. The method of claim 1, wherein the PPDU is used for multi-static sensing.

7. A computer readable medium comprising instructions, which when executed by a processor of a device, cause the device to carry out the method of claim 1.

8. A computer program comprising instructions which, when the program is executed by a processor of a computer, cause the computer to carry out the method of claim 1.

9. An apparatus comprising:
at least one processor; and
at least one machine-readable medium storing executable instructions which when executed by the at least one processor configure the apparatus to:
generate a physical layer (PHY) protocol data unit (PPDU), the PPDU being formatted for use in multi-static sensing, the PPDU comprising:
one or more synchronization (SYNC) fields;
a synchronization pad (SYNC Pad) field;
if the PPDU includes a data field: in an enhanced directional multi-gigabit (EDMG)-Header-A, a PHY layer service data unit (PSDU) Length field set to specify a total length of: the data field, plus each one of the one or more SYNC fields, plus the SYNC Pad field; and
if the PPDU excludes the data field: in the enhanced directional multi-gigabit (EDMG)-Header-A, the PHY layer service data unit (PSDU) Length field set to specify a total length of: each one of the one or more SYNC fields, plus the SYNC Pad field; and
transmit the PPDU, such that at least two different portions of the PPDU are directionally transmitted toward different respective stations (STAs).

10. The apparatus of claim 9, wherein the PPDU further comprises a Length field and a Training Length field within a legacy header (L-Header) of the PPDU, the Length field set to specify a total length of all fields of the PPDU from the EDMG-Header-A to the SYNC Pad field, and inclusive of the EDMG-Header-A and the SYNC Pad field, the Length field together with Training Length field set to estimate the whole PPDU duration.

11. The apparatus of claim 9, wherein the PPDU is an aggregated multi-user PPDU (A-PPDU).

12. The apparatus of claim 9, wherein the PPDU is used for multi-static sensing.
